(19) United States
(12) Patent Application Publication
(10) Pub. No.: US 2026/0169920 A1
(43) Pub. Date: Jun. 18, 2026

(54) METHOD TO PERFORM ADAPTER SNOOP IN HARDWARE USING SPLIT STRUCTURE CACHE FOR SNOOP DATA CONSTRUCTS

(71) Applicant: INTERNATIONAL BUSINESS MACHINES CORPORATION, ARMONK, NY (US)

(72) Inventors: DEEPANKAR BHATTACHARJEE, BANGALORE (IN); GIRISH GOPALA KURUP, JAGADISHNAGAR (IN); HOWARD MICHAEL HAYNIE, WAPPINGERS FALLS, NY (US); MICHAEL JAMES BECHT, POUGHKEEPSIE, NY (US); SUBHASIS SAMANTA, BENGALURU (IN)

(21) Appl. No.: 18/982,675

(22) Filed: Dec. 16, 2024

(51) Int. Cl. G06F 12/0831; G06F 12/0893

(52) U.S. Cl. CPC G06F 12/0831; G06F 12/0893

(57) ABSTRACT

Adapter snooping in hardware using a split structure cache includes: receiving, by a hardware snooping module, a completion packet from a network adapter, storing, by the hardware snooping module, a data structure associated with the completion packet in a split structure cache included within the hardware snooping module, performing, by the hardware snooping module, a hardware snoop on the data structure, including updating the data structure based on the completion packet, where the hardware snooping module is configured to determine whether to interrupt firmware based on the hardware snoop of the data structure, and sending, by the hardware snooping module, the updated data structure to system memory.

### BACKGROUND

### Field of the Disclosure

The field of the disclosure is data processing, or, more specifically, methods, systems, and products for adapter snooping in hardware using a split structure cache.

### Description of Related Art

Hardware snooping is a technique used in multi-processor systems to maintain cache coherency, ensuring that all processors have access to the most up-to-date data. It involves a mechanism where each cache controller monitors the system bus for memory transactions.

### SUMMARY

Methods, apparatus, and systems for adapter snooping in hardware using a split structure cache according to various embodiments are disclosed in this specification. In accordance with one aspect of the present disclosure, a method of adapter snooping in hardware using a split structure cache includes: receiving, by a hardware snooping module, a completion packet from a network adapter, storing, by the hardware snooping module, a data structure associated with the completion packet in a split structure cache included within the hardware snooping module, performing, by the hardware snooping module, a hardware snoop on the data structure, including updating the data structure based on the completion packet, where the hardware snooping module is configured to determine whether to interrupt firmware based on the hardware snoop of the data structure, and sending, by the hardware snooping module, the updated data structure to system memory.

In accordance with another aspect of the present disclosure, a system for adapter snooping in hardware using a split structure cache may include a system memory, a network adapter, a firmware, and a hardware snooping module including: a split structure cache having a first memory and a second memory, and a snooping controller configured to: receive a completion packet from the network adapter, store a data structure associated with the completion packet in the split structure cache, perform a hardware snoop on the data structure, including updating the data structure based on the completion packet, and send the updated data structure to the system memory.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 is a block diagram of an example system configured for adapter snooping in hardware using a split structure cache in accordance with embodiments of the present disclosure.

FIG. 2 is a block diagram of an example computing environment configured for adapter snooping in hardware using a split structure cache according to some embodiments of the present disclosure.

FIG. 3 is a flowchart of an example method for adapter snooping in hardware using a split structure cache according to some embodiments of the present disclosure.

FIG. 4 is a flowchart of another example method for adapter snooping in hardware using a split structure cache according to some embodiments of the present disclosure.

FIG. 5 is a flowchart of another example method for adapter snooping in hardware using a split structure cache according to some embodiments of the present disclosure.

### DETAILED DESCRIPTION

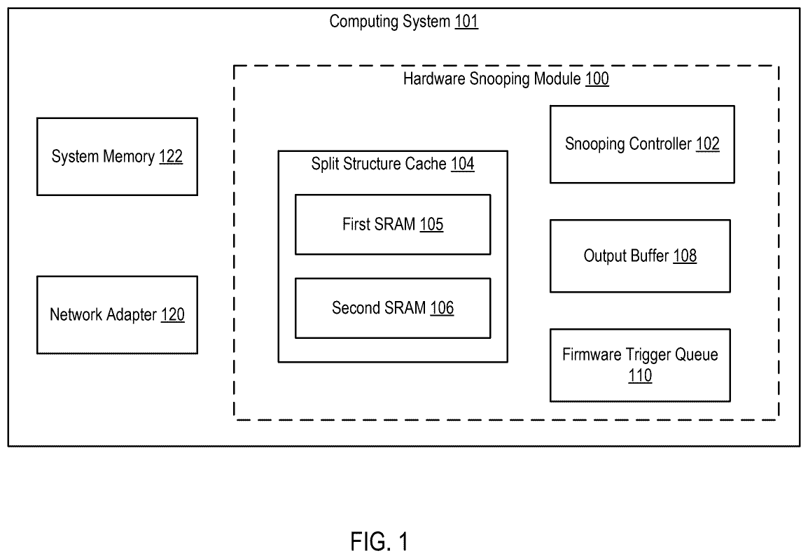

Exemplary methods, systems, and products for adapter snooping in hardware using a split structure cache in accordance with the present disclosure are described with reference to the accompanying drawings, beginning with FIG. 1. FIG. 1 sets forth a block diagram of an example system configured for adapter snooping in hardware using a split structure cache in accordance with embodiments of the present disclosure. The example of FIG. 1 includes computing system 101, which includes system memory 122, network adapter 120, and hardware snooping module 100. The computing system 101 also includes firmware (not shown in FIG. 1), which may be included within system memory, or may be included within the system separate from system memory.

The example network adapter 120 of FIG. 1 is configured to couple computing system 101 to another device or network. In some embodiments, the network adapter 120 is a PCIe (Peripheral Component Interconnect Express) adapter. The network adapter is configured to carry out PCIe transactions. Upon completing a PCIe transaction, the network adapter is configured to send a completion packet comprising data that represents the completion of a PCIe transaction. The completion packet may write or store a Completion Queue Entry (CQE) in a completion queue included within the network adapter.

The example system memory of FIG. 1 is configured with a memory hierarchy and is also configured with a memory coherency mechanism. In one embodiment, the memory coherency is turned on throughout the entire remaining methods of the present disclosure. In the example system of FIG. 1, the split structure cache included in the hardware snooping module is separate from the system memory hierarchy.

The example hardware snooping module 100 of FIG. 1 includes a snooping controller 102, output buffer 108, firmware trigger queue 110, and a split structure cache 104 (which in turn includes a first SRAM (static random-access memory) 105 and a second SRAM 106). Hardware snooping module is configured to perform an adapter snoop in hardware and is also configured to interrupt firmware responsive to hardware snooping. The hardware snooping module 100 is configured to monitor all adapter activity, including monitoring all completion queue activity and may interpret each CQE as it is being written to the completion queue. That is, the hardware snooping module is configured to retrieve (or intercept) each completion packet associated with the network adapter, and perform hardware snooping operations based on each completion packet retrieved from the network adapter.

In the example computing system of FIG. 1, the firmware may configure one or more data constructs (or data structures) for a host interface to define the unique criteria for outbound and inbound notifications. These criteria include packet counts, packet arrival rates, timers for packet blocking parameters. That is, the firmware is configured to create and store a data structure within system memory 122 for each adapter (such as network adapter 120) coupled to the system. Each data structure has a unique memory area, within system memory, assigned for each Host Interface for all TX and RX Queues of the adapter. The hardware snooping module is configured to perform a hardware snoop on each CQE packet (completion packet) associated with the adapter, performs a memory access for a data construct look up, performs snoop parameter checks created by Firmware (to determine whether to interrupt the firmware based on the hardware snoop), and then performs a hardware update to update the data structure stored in system memory. On successful snoop parameter checks, the hardware snooping module is configured to trigger a firmware trigger queue write (followed by performing a firmware interrupt) with detailed reason for the firmware to take a next action.

Each hardware snoop is performed based on adapter type, virtual function, connection id, queue id, and the like, all of which may be included within a completion packet. The hardware snooping module is configured to fetch the data structure (corresponding with the particular network adapter, indicated in the completion packet), which include both hardware fields and software fields, from system memory 122. After fetching the data structure, the hardware snooping module stores the data structure in the split structure cache 104. When storing the data structure in the split structure cache, a software portion (having the software fields) of the data structure is stored within the first SRAM 105 and a hardware portion (having the hardware fields) is stored within the second SRAM 106. In one embodiment, the second SRAM includes two write ports, with one configured to write fetched data to the SRAM such as the data structure fetched from system memory) and another port to write updates to the hardware fields of the data structure during or after a hardware snoop.

Then, the hardware snooping module determines the snooping function that needs to be performed by the hardware snooping module, based on the data structure and the completion packet. That is, the hardware snooping module may reference the data structure and determine which hardware fields to monitor and update in order to send the firmware interrupt to the firmware. Said another way, the firmware may indicate, in the data structure, one or more hardware fields (along with one or more corresponding field values) that must be met before the firmware is to be triggered to proceed with a next action. In one embodiment, the firmware running in the computing system 101 is configured to receive the interrupt and take the next set of actions based on the interrupt and hardware snoop.

The hardware snooping module is also configured to then update the one or more hardware fields within the stored data structure in the split structure cache. Specifically, the hardware snooping module updates the one or more hardware fields stored within the hardware portion of the data structure in the second SRAM 106. The update is carried out based on the completion packet from the network adapter. Each subsequent completion packet may result in a corresponding update to the data structure, where each update to the data structure is propagated back to system memory, in order to keep the data structure within system memory up to date. The data structure stored in the split structure cache is tagged based on adapter ID, virtual function, connection id, queue id, and the like. In one embodiment, all new completion packets having same IDs will refer and use the same internally stored (in the split structure cache) data structures and thus will be used as a “Level-1 cache” for all new and local reference to the same data structure. This enables efficient parallel access of data constructs and snooping and not stall pipeline for same connection packets until the new data is reflected in next level cache memory. In one embodiment, the firmware is configured to update the software fields of the data structures in system memory, and the hardware snooping module is configured to update the hardware fields via the snooping method described in the present disclosure.

In one embodiment, the computing system is configured to perform a multi-point coherency check. Such a multi-point coherency check may include three separate steps. Namely, a first step of, when a new completion packet snoop data structure is fetched from coherent system memory, before storing the data construct in the split structure cache 104, first check the output buffer 108 to determine, by the snooping controller, which location includes the most up to date version of the needed data construct. A second step of the multi-point coherency check includes, when processing a data structure in the hardware snooping module, ensuring that the previous cycle data structure is referred to if a snoop was performed on the same connection (i.e., same adapter). The third step includes, when updating the output buffer with a processed (updated) data structure (to be written to system memory), determine if a subsequent/next completion packet to be processed by the hardware snooping module is from the same connection (i.e., same adapter), and store metadata indicate where to find the most up to date version of the data structure.

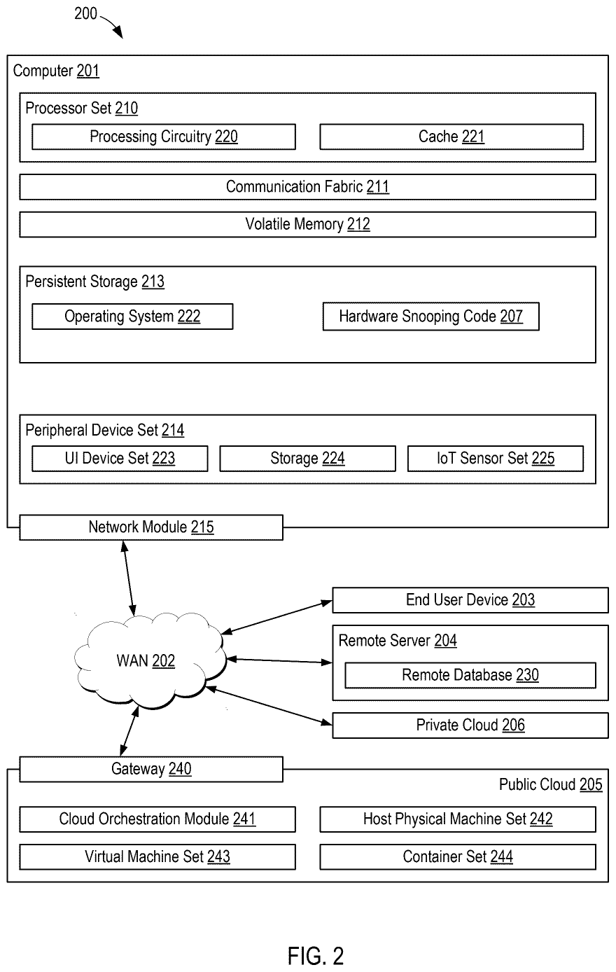

For further explanation, FIG. 2 sets forth a block diagram of computing environment 200 configured for adapter snooping in hardware using a split structure cache in accordance with embodiments of the present disclosure. Computing environment 200 contains an example of an environment for the execution of at least some of the computer code involved in performing the inventive methods, such as hardware snooping code 207 or operating system 222. In addition to hardware snooping code 207, computing environment 200 includes, for example, computer 201, wide area network (WAN) 202, end user device (EUD) 203, remote server 204, public cloud 205, and private cloud 206. In this example embodiment, computer 201 may include the computing system 101 shown in FIG. 1, and includes processor set 210 (including processing circuitry 220 and cache 221), communication fabric 211, volatile memory 212, persistent storage 213 (including operating system 222 and hardware snooping code 207, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244. In one embodiment, the hardware snooping code 207 is included in the hardware snooping module 100 and is configured to receive a completion packet, store a data structure in a split structure cache, perform a hardware snoop, and send an updated data structure to system memory. In another embodiment, the hardware snooping code 207 is included within the operating system 222.

Computer 201 may take the form of a desktop computer, laptop computer, tablet computer, smart phone, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in hardware snooping code 207 in persistent storage 213.

Communication fabric 211 is the signal conduction path that allows the various components of computer 201 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 212 is any type of volatile memory now known or to be developed in the future. Examples include dynamic type random-access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in hardware snooping code 207 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215. Network module 215 may be configured to communicate with other systems or devices, such as sensors 225, for receiving sensor measurements.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

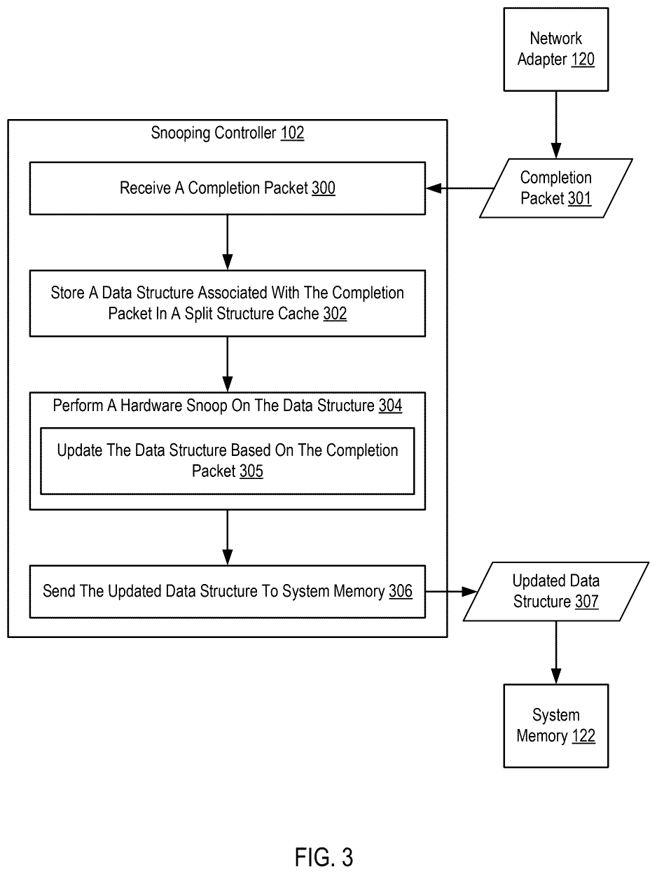

For further explanation, FIG. 3 sets forth a flow chart illustrating an exemplary method of adapter snooping in hardware using a split structure cache according to embodiments of the present disclosure. The method of FIG. 3 includes receiving 300 a completion packet. Receiving 300 a completion packet may be carried out by snooping controller 102 obtaining the completion packet 301 from network adapter 120. In one embodiment, receiving the completion is carried out by the snooping controller intercepting the completion packet from the adapter. In another embodiment, the network adapter is configured to send the completion packet directly to the snooping controller. In some embodiments, the network adapter is a PCIe adapter. In such embodiments, the completion packet 301 comprises a portion of data that represents the completion of a PCIe transaction by the adapter.

The method of FIG. 3 also includes storing 302 a data structure associated with the completion packet in a split structure cache. Storing 302 a data structure associated with the completion packet in a split structure cache may be carried out by snooping controller 102 retrieving the data structure from system memory and storing it within the split structure cache included within the hardware snooping module. In one embodiment, the data structure is specific to the network adapter, and may include tags based on adapter ID, virtual function, connection ID, queue ID, and the like. In some embodiments, the data structure is originally configured by firmware for a specific network adapter to define the unique criteria for outbound and inbound notifications, where the criteria includes packet counts, packet arrival rates, and timers for packet blocking parameters. In some embodiments, the data structure may comprise a software portion and a hardware portion. In some embodiments, the split structure cache includes a first memory (such as a first SRAM) and a second memory (such as a second SRAM). In some embodiments, when storing the data structure in the split structure cache, the software portion of the data structure is stored in the first SRAM and the hardware portion of the data structure is stored in the second SRAM.

The method of FIG. 3 also includes performing 304 a hardware snoop on the data structure. Performing 304 a hardware snoop on the data structure may be carried out by snooping controller 102 parsing the completion packet and determining how to update the data structure. The method of FIG. 3 also includes, as part of performing 304 a hardware snoop on the data structure, updating 305 the data structure based on the completion packet. Updating 305 the data structure based on the completion packet may be carried out by snooping controller 102 updating one or more hardware fields of the data structure based on the information included within the completion packet from the adapter. By snooping the completion packet, the snooping controller is configured to keep the data structure up to date based on the completion packets received from the adapter. Each completion packet received by the snooping controller corresponds to a subsequent update to the data structure based on that completion packet.

The method of FIG. 3 also includes sending 306 the updated data structure to system memory. Sending 306 the updated data structure to system memory may be carried out by snooping controller 102 copying the updated data structure 307 over to system memory in order to keep the data structure stored in system memory up to date based on completion packets from the adapter. Each completion packet received by the snooping controller corresponds to a subsequent update to the data structure in the split structure cache based on that completion packet, followed by a subsequent update being sent to the memory to keep the data structure up to date based on every completion packet output by the network adapter. By keeping the data structures up to date in memory using the hardware snooping module, as described in the present disclosure, more system resources are free to perform other computing operations (instead of conventional systems that have to keep the data structures up to date without relying on hardware snooping).

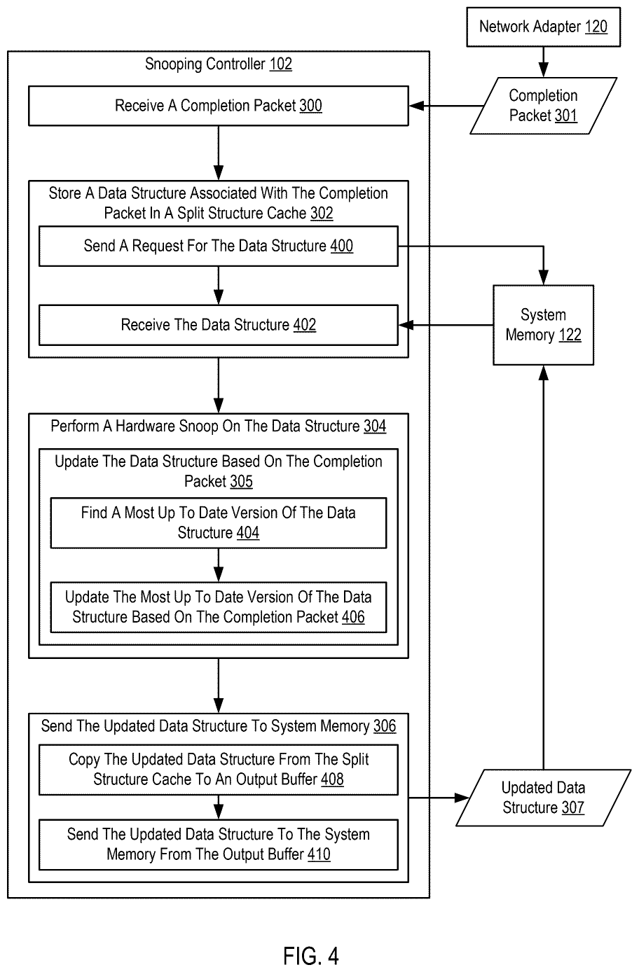

For further explanation, FIG. 4 sets forth a flow chart illustrating another exemplary method of adapter snooping in hardware using a split structure cache according to embodiments of the present disclosure. The method of FIG. 4 differs from the method of FIG. 3 in that the method of FIG. 4 further includes, as part of storing 302 a data structure associated with the completion packet in a split structure cache, sending 400 a request for the data structure. Sending 400 a request for the data structure may be carried out by snooping controller 102 sending a request for a specific data structure to system memory 122. The request may identify the specific network adapter (e.g., using an adapter ID) for which the data structure is being requested. A request for the data structure may be sent to system memory responsive to each completion packet received from the network adapter.

The method of FIG. 4 also includes, as part of storing 302 a data structure associated with the completion packet in a split structure cache, receiving 402 the data structure. Receiving 402 the data structure may be carried out by snooping controller 102 receiving the data structure from system memory 122 in response to the request. A data structure may be received by snooping controller 102 from system memory responsive to each completion packet received from the network adapter.

The method of FIG. 4 also includes, as part of updating 305 the data structure based on the completion packet, finding 404 a most up to date version of the data structure. Finding 404 a most up to date version of the data structure may be carried out by snooping controller 102 checking multiple locations within the system to determine where the most up to date version of the data structure is stored, and using that data structure when storing the data structure in split structure cache or when updating the data structure already stored there. In some embodiments, the snooping controller is configured to, when finding the most up to date version of the data structure, check the system memory, the split structure cache, the output queue included within the snooping module, and the like. In some embodiments, the hardware snooping module includes metadata that may include information indicating where the most up to date version of the data structure is stored. In such an embodiment, finding the most up to date version includes references the metadata included in the snooping module to determine where to retrieve the most up to date version of the data structure. In the example method of FIG. 4, finding the most up to date version is carried out as part of the hardware snoop, performed while updating the data structure that has been stored in split structure cache. In such an embodiment, the data structure is updated to be the most up to date version, and is then subsequently again updated 406 based on the completion packet. In another embodiment, finding the most up to date version may be performed as part of storing the data structure in the split structure cache responsive to a completion packet from the adapter. In such an embodiment, the snooping controller determines where the most up to date data structure is located, retrieves it, and stores that version of the data structure in split structure cache (to be later updated during the snoop based on the completion packet).

The method of FIG. 4 also includes, as part of updating 305 the data structure based on the completion packet, updating 406 the most up to date version of the data structure based on the completion packet 301. Updating 406 the most up to date version of the data structure based on the completion packet 301 may be carried out by snooping controller 102 updating the data structure in split structure cache based on the completion packet only once the split structure cache includes the most up to date version of the data structure. Such an embodiment is important when subsequent completion packets are received from the network adapter. For example, in response to receiving a first completion packet, the snooping controller stores the data structure in split structure cache, updates the data structure based on the first completion packet, and then sends the updated data structure 307 to system memory. In such an example, if a subsequent completion packet is received from the network adapter prior to the updated data structure arriving at system memory, then the data structure retrieved from system memory responsive to the subsequent completion packet will not be the most up to date version of the data packet (as it has not yet been updated based on the first completion packet). Accordingly, by finding the most up to date version of the data structure (whether that be during the storing of the data structure or during the hardware snoop), the most up to date version of the data structure (which, in this example, may be stored in the split structure cache or in the output buffer) can be updated based on that subsequent completion packet. In some embodiments, the data structure is serially updated for each completion packet from the adapter.

The method of FIG. 4 also includes, as part of sending 306 the updated data structure 307 to system memory, copying 408 the updated data structure from the split structure cache to an output buffer. Copying 408 the updated data structure from the split structure cache to an output buffer may be carried out by snooping controller 102 copying the updated data structure over to the output buffer included in the snooping module 100. The method of FIG. 4 also includes, as part of sending 306 the updated data structure to system memory, sending 410 the updated data structure to the system memory from the output buffer. Sending 410 the updated data structure to the system memory from the output buffer may be carried out by snooping controller 102, after copying the updated data structure over to the output buffer, copying the updated data structure over to system memory in order to keep the data structure stored in system memory up to date based on the most recent completion packet received from the network adapter. By utilizing an output buffer when sending the updated data structure to system memory, the snooping module is configured to continue to update the data structure in split structure cache responsive to subsequent completion packets. That is, by copying the updated data structure to an output buffer, the data structure in the split structure cache may then be ready for a subsequent update based on any subsequent completion packets, even if the first updated data structure has not yet completed being sent to system memory. Accordingly, in an embodiment where multiple subsequent ‘updated data structures’ are copied over to the output buffer prior to one of the updated data structures being successfully delivered to system memory, the snooping controller is configured to send the updated data structures to system memory from the output buffer serially in the order in which they were copied over to the output buffer. In this example embodiment, the system memory will continue to have it's data structure serially updated for each completion packet from the adapter, independent of how quickly subsequent completion packets are received from the network adapter.

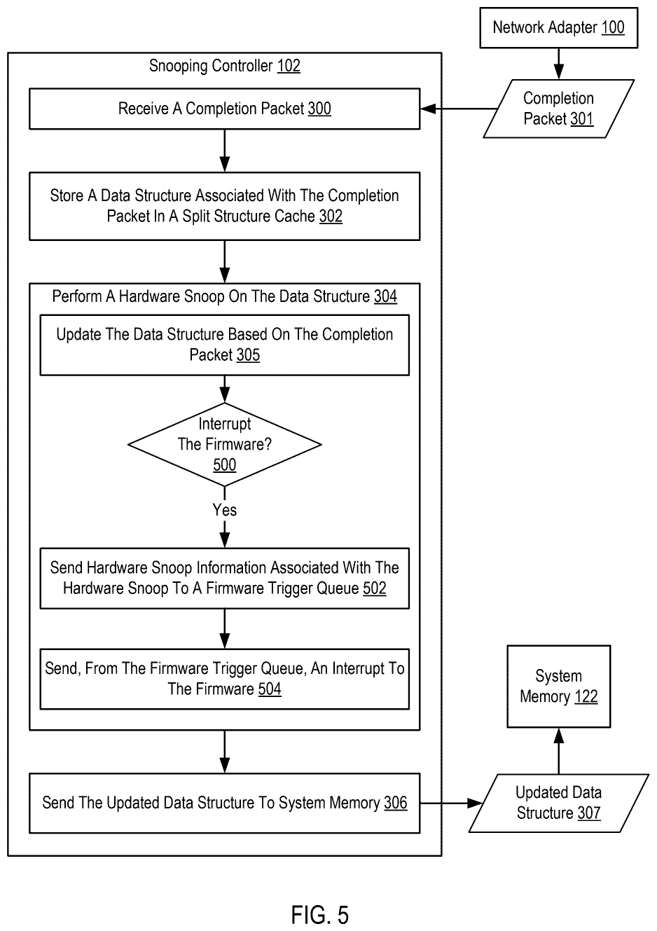

For further explanation, FIG. 5 sets forth a flow chart illustrating another exemplary method of adapter snooping in hardware using a split structure cache according to embodiments of the present disclosure. The method of FIG. 5 differs from the method of FIG. 3 in that the method of FIG. 5 further includes, as part of performing 304 a hardware snoop on the data structure, and after updating 305 the data structure based on the completion packet, determining 500 whether to interrupt the firmware. Determining 500 whether to interrupt the firmware may be carried out by snooping controller 102 comparing one or more fields within the updated data structure 307 with parameters associated with a firmware trigger indicated in the data structure. For example, the data structure may specify (such as within the software portion of the data structure) when the firmware should be triggered based on one or more values of the data structure reaching one or more threshold values. By continually updating the data structure for each completion queue and comparing the fields included in the data structure with one or more firmware triggering thresholds included in the data structure, the snooping controller is configured to trigger the firmware as soon as possible based on the triggering conditions being met.

The method of FIG. 5 also includes, responsive to determining to interrupt the firmware, sending 502 hardware snoop information associated with the hardware snoop to a firmware trigger queue. Sending 502 hardware snoop information associated with the hardware snoop to a firmware trigger queue may be carried out by snooping controller 102 sending, to the firmware, data which indicates why the firmware should be triggered. In one embodiment, the hardware snoop information sent to the firmware trigger queue includes an indication of the completion packet ID, the adapter ID, an identifier of which one or more thresholds have been met, and any other data included in the data structure or completion packet.

The method of FIG. 5 also includes, responsive to sending 502 hardware snoop information associated with the hardware snoop to a firmware trigger queue, sending 504, from the firmware trigger queue, an interrupt to the firmware. Sending 504, from the firmware trigger queue, an interrupt to the firmware may be carried out by snooping controller 102 sending, to the firmware, the data stored in the firmware trigger queue. In one embodiment, the interrupt also includes one or more instructions to be carried out by the firmware. By interrupting the firmware, the snooping module is configured to provide the firmware with an interrupt only when certain parameters are met and when the firmware needs it, thereby increasing system efficiency and reducing unnecessary resource consumption. Further, the interrupt may be sent to the firmware sooner using the hardware snooping module because the interrupt is sent prior to delivering the updated data structure to system memory.

In view of the explanations set forth above, readers will recognize that the benefits of adapter snooping in hardware using a split structure cache according to embodiments of the present disclosure include:
Increasing system performance by allowing for a hardware snooping module to keep the data structure up to date, thereby saving system resources.
Increasing system efficiency by allowing for a faster response to send firmware triggers to the firmware.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random-access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of adapter snooping in hardware using a split structure cache, the method comprising:
receiving, by a hardware snooping module, a completion packet from a network adapter;
storing, by the hardware snooping module, a data structure associated with the completion packet in a split structure cache included within the hardware snooping module;
performing, by the hardware snooping module, a hardware snoop on the data structure, including updating the data structure based on the completion packet, wherein the hardware snooping module is configured to determine whether to interrupt firmware based on the hardware snoop of the data structure; and
sending, by the hardware snooping module, the updated data structure to system memory.

2. The method of claim 1, wherein the split structure cache includes a first SRAM (static random-access memory) and a second SRAM.

3. The method of claim 2, wherein the data structure includes a software portion and a hardware portion, and wherein storing the data structure in the split structure cache includes storing the software portion of the data structure in the first SRAM and storing the hardware portion of the data structure in the second SRAM.

4. The method of claim 1, wherein storing the data structure includes:
sending, by the hardware snooping module, a request to the system memory for the data structure corresponding with the completion packet;
receiving, by the hardware snooping module in response to the request, the data structure from the system memory; and
storing, by the hardware snooping module, the data structure in the split structure cache.

5. The method of claim 1, wherein updating the data structure includes:
finding a most up to date version of the data structure; and
updating the most up to date version of the data structure based on the completion packet.

6. The method of claim 1, wherein sending the updated data structure to the system memory includes:
copying, by the hardware snooping module, the updated data structure from the split structure cache to an output buffer included within the hardware snooping module; and
sending, by the hardware snooping module from the output buffer, the updated data structure to the system memory, wherein the system memory is coherent with the split structure cache.

7. The method of claim 1, further comprising, responsive to determining, by the hardware snooping module and based on the hardware snoop, to interrupt the firmware:
sending hardware snoop information associated with the hardware snoop to a firmware trigger queue included within the hardware snooping module; and
sending, from the firmware trigger queue, an interrupt to the firmware.

8. The method of claim 1, wherein the network adapter is a PCIe adapter.

9. An apparatus for adapter snooping in hardware using a split structure cache, the apparatus comprising:
a split structure cache comprising a first memory and a second memory; and
a snooping controller configured to:
receive a completion packet from a network adapter;
store a data structure associated with the completion packet in the split structure cache;
perform a hardware snoop on the data structure, including updating the data structure based on the completion packet; and
send the updated data structure to system memory.

10. The apparatus of claim 9, wherein the first memory comprises a first SRAM (static random-access memory) and the second memory comprises a second SRAM.

11. The apparatus of claim 10, wherein the data structure includes a software portion and a hardware portion, and wherein storing the data structure in the split structure cache includes storing the software portion of the data structure in the first SRAM and storing the hardware portion of the data structure in the second SRAM.

12. The apparatus of claim 9, wherein storing the data structure includes:
sending, by the snooping controller, a request to the system memory for the data structure corresponding with the completion packet;
receiving, by the snooping controller in response to the request, the data structure from the system memory; and
storing, by the snooping controller, the data structure in the split structure cache.

13. The apparatus of claim 9, wherein updating the data structure includes:
finding, by the snooping controller, a most up to date version of the data structure; and
updating the most up to date version of the data structure based on the completion packet.

14. The apparatus of claim 9, further comprising an output buffer, and wherein sending the updated data structure to the system memory includes:
copying, by the snooping controller, the updated data structure from the split structure cache to the output buffer; and
sending, by the snooping controller from the output buffer, the updated data structure to the system memory, wherein the system memory is coherent with the split structure cache.

15. The apparatus of claim 9, wherein the snooping controller is further configured to determine whether to interrupt firmware based on the hardware snoop of the data structure.

16. The apparatus of claim 15, further comprising a firmware trigger queue, and wherein the snooping controller is further configured to:
send, based on a determination to interrupt the firmware, hardware snoop information associated with the hardware snoop to the firmware trigger queue; and
send, from the firmware trigger queue, an interrupt to the firmware.

17. A system for adapter snooping in hardware using a split structure cache, the system comprising:
a system memory;
a network adapter;
a firmware; and
a hardware snooping module comprising:
a split structure cache comprising a first memory and a second memory; and
a snooping controller configured to:
receive a completion packet from the network adapter;
store a data structure associated with the completion packet in the split structure cache;
perform a hardware snoop on the data structure, including updating the data structure based on the completion packet; and
send the updated data structure to the system memory.

18. The system of claim 17, wherein the network adapter is a PCIe adapter.

19. The system of claim 17, wherein the data structure includes a software portion and a hardware portion, and wherein storing the data structure in the split structure cache includes storing the software portion of the data structure in the first memory and storing the hardware portion of the data structure in the second memory.

20. The system of claim 17, wherein updating the data structure includes:
finding, by the snooping controller, a most up to date version of the data structure; and
updating the most up to date version of the data structure based on the completion packet.
